(19) United States
(12) Patent Application Publication
(10) Pub. No.: US 2007/0170251 A1
(43) Pub. Date: Jul. 26, 2007

(54) Method of configuring a transaction and system for processing same

(76) Inventor: Joseph M. Elias, New Stanton, PA (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/641,242

(22) Filed: Dec. 19, 2006

(30) Foreign Application Priority Data
Dec. 19, 2005 (IE) S2005/0845

(51) Int. Cl. G06K 15/00; G07G 1/14; G06Q 20/00

(52) U.S. Cl. 235/383; 705/16; 705/14

(57) ABSTRACT

A method of configuring a transaction checkout at a local network-connected terminal is disclosed, in which a checkout module and transaction data are loaded from a remote terminal. A conditional transaction module is also loaded, which processes the transaction data. A terminal user is provided with an input choice to either confirm the transaction data to the remote terminal or to chance the transaction data. The price data of the transaction data is increased if the transaction data chancing is unsuccessful and the price data of the transaction data is decreased if the transaction data chancing is successful.

### FIELD OF THE INVENTION

The present invention relates to a novel configuration of transaction checkouts and, more particularly, the present invention relates to a novel configuration of virtual or physical transaction checkouts with a conditional transaction module.

### BACKGROUND OF THE INVENTION

Physical transaction checkouts are well known, and are used in most retail environments. An example of such a physical retail environment is shown in FIG. 1, in which a customer 101 is shown as having selected an item 102 which he wishes to purchase. The item 102 is habitually presented to a retail staff member 103, who inputs the respective price of the item in a point-of-sale terminal 104, which is a data processing terminal, before requesting payment from customer 101 to complete the transaction. Such payment is effected by the customer 101 with any conventional payment means, such as with cash, a cheque, a voucher or a payment card 105. In the case of a payment card 105, the customer 101 lends the card to the staff member 103 for inputting the details thereof in the POS terminal 104, either by reading the data stored in a magnetic stripe 106 of the card with a magnetic card reader 107 interfaced with POS terminal 104, or reading the data stored in a microprocessor 108 of the card with a chip-and-PIN device 109 interfaced with POS terminal 104, depending on the configuration of the card 105 The terminal 104 then traditionally obtains a remote authorization for debiting the card account, or is configured to authorise the debiting of the card account locally, whereby the card account of the customer 101 is debited with the price of the item 102, the transaction is complete and customer 101 has purchased item 102. The retail store account is eventually credited with the amount debited from the card, minus a commission deducted from the card transaction by financial institutions permitting such card transactions.

The typical constituent parts of data processing terminal 104 are shown in further detail in FIG. 2. Terminal 104 includes processing means 201, memory means 202 and 203, goods identification means 204, a modem 205, a data input/output interface 206 and data display means 207, all of which are connected by a data input/output bus 208, over which they communicate and to which further or optional components of terminal 104, such as card readers 107, 109, are similarly linked via I/O interface 206 in order to provide the functionality described in FIG. 1

Memory means 202 includes for instance a Non-Volatile Random Access Memory (NVRAM) which provides non-volatile storage of instructions and data (such as product description and price for product 102) for processing means 201, which is a Central Processing Unit (CPU) such as a general-purpose microprocessor, acting as the main controller of terminal 104. Memory means 203 includes for instance a Random Access Memory (RAM), which is used by CPU 201 at runtime to accumulate transaction data of any given transaction and to temporarily store instructions and/or data for CPU 201 obtained via modem 205. Transaction data of any given transaction comprises for instance the respective prices of multiple products 102 fetched from NVRAM 202 upon each of said products being identified via goods identification means 204, which in the example is a barcode scanner. If a payment card is used to conduct the transaction, transaction data in RAM 203 will also include the card details obtained from either of readers 107 or 109 and transmitted via I/O interface 206.

Terminal communication functionality is provided by modem 205, which provides the interface to the remote terminals 207 of the financial institutions from which card authorization is sought, or to which batched card transactions are periodically sent for further processing and eventual account debiting and crediting, as described hereinabove.

With respect to the pervasive development of the Internet, virtual transaction checkouts have also become well known, and have become widely used both by physical retail environments such as depicted in FIG. 1 to increase their sales without however incurring any real estate expenditure, and by retail stores which are entirely virtual, i.e. which have no traditional, physical presence whatsoever, if only for a warehouse from which to despatch goods, when these are not despatched directly from the manufacturer instead. An example of such a virtual retail environment is shown in FIG. 3, in which the customer 101 who is for instance at home, is shown interfacing with a Personal Computer (PC), which is another type of data processing terminal 301. The customer 101 accesses virtual stores via a Wide Area Network (WAN) such as the Internet 302, via an Internet Service Provider 303. The virtual stores are a combination of textual, image, video and/or audio data broadcast under the form of Web pages 304 by other remote terminals 305, and which data is usually stored at said remote terminals 305 in databases of products or services and broadcast therefrom on request. The user requests such broadcasts by providing selection input with a combination of a keyboard 306 and a human/terminal interface such as a conventional mouse 307, the selection amounting to the navigation of network addresses and selection of respective data contents thereof for retrieval and display as said Web pages on a Video Display Unit (VDU) 308 of terminal 301.

When using the Internet to purchase goods or services presented on web pages of a virtual store, a customer will eventually be presented with a web page 304 configured as an online transaction checkout, in which the customer is requested to enter payment details and then confirm the transaction to the remote terminal hosting the virtual store, before physical goods can be despatched or services performed. Such payment details traditionally comprise either particulars of a payment card 105, whereby the processing of the transaction does not differ from the physical transaction described in FIG. 1, save for the fact that the card data stored in the stripe 106 or microprocessor 108 is not read but the card particulars (card number, expiry date and the like) are input by customer 101 instead in data fields of the checkout, or particulars of accounts with an online payment system such as Paypal™, Nochex™ or BidPay™. An online transaction checkout is usually secured against interception of and/or unauthorised access to the payment details for fraudulent use, by a combination of encoding, ciphering and/or encrypting of the distributed data.

The typical constituent parts of data processing terminals 301, 305 are shown in further detail in FIG. 4. Terminal 301 is a computer terminal configured with a data processing unit 301, which is interfaced with data display means (VDU 308), data input means (keyboard 306 and mouse 307) and data input/output means such as WAN connection 302, magnetic data-carrying medium reader/writer 401 and optical data-carrying medium reader/writer 402.

Within data processing unit 301, a central processing unit (CPU) 403, such as an Intel Pentium 4 manufactured by the Intel Corporation, provides task co-ordination and data processing functionality. Instructions and data for the CPU 403 are stored in main memory 404 and a hard disk storage unit 405 facilitates non-volatile storage of data and several sets of instructions for CPU 403. A modem 406 provides a wired connection to the Internet 302. A universal serial bus (USB) input/output interface 407 facilitates connection to the keyboard and pointing device 306, 307. All of the above devices are connected to a data input/output bus 408, to which said magnetic data-carrying medium reader/writer 401 and optical data-carrying medium reader/writer 402 are also connected. A video adapter 409 receives CPU instructions over said bus 408 for outputting processed data to VDU 308.

In the embodiment, terminal 301 is of the type generally known as a compatible Personal Computer (‘PC’), but may equally be any device configured with data inputting, processing and outputting means providing at least the functionality described above. Any such device may include, but is not limited to, an iMac® computer manufactured by the Apple® Corporation of Cupertino, Calif., USA; a Portable Digital Assistant (PDA) such as a Palm m505® manufactured by PalmOne® Inc. of Milpitas, Calif., USA; a Portable Digital Computer (PDC) such as an IPAQ® manufactured by the Hewlett-Packard® Company of Palo Alto, Calif., USA; or even a mobile phone such as a Sony Ericsson k700i manufactured by the Sony Ericsson Mobile Communications AB® Group in Sweden, all of which are generally configured with processing means, data display means, memory means, data input and output means and wired or wireless network connectivity.

A representation of on-line transaction check out 304 as displayed on VDU 308 is provided in FIG. 5. The virtual check out typically first comprises a summary 501 of the order particulars, including the products selected by the user 101, the respective quantity of each product or service selected and respective prices. The check out will preferably also include shipping charges if applicable and a total amount payable for the order.

A second portion of the virtual check out will be dedicated to collecting payment details as described hereinbefore and depending upon the store payment choices, will comprise either only a payment card details section 502 or will also include respective network addresses represented as user selectable buttons 503 of virtual financial institutions (Paypal™, No Cheques™, Bit Pay™, in the example) in a further portion 504 of the virtual checkout. In accordance with the known art of virtual transaction checkouts, the card payment section 502 includes a field 505 for entering the card number, a field 506 for entering the expiry date of the card and a selection of user-selectable buttons 507 respectively corresponding to card schemes for identifying the particular type of payment card (Mastercard, Visa or America Express in the example). Upon entering the details, customer 101 may eventually confirm the order and payment for same with selecting a “pay” button 508. Transaction checkouts as described in relation to FIGS. 1 and 5 are well-known and the respective functionalities of those checkouts are very much standardised, as there purpose is simply to confirm the particulars of a transaction and the payment for the said transaction. It would be advantageous to configure such transaction checkouts with additional functionality, for instance in order to increase any of the number of customers 101 accessing a physical or virtual retail environment, increase the transaction conversion rate of virtual stores (understood as orders confirmed and paid for, as apposed to orders placed up to a point but never actually confirmed), increasing the revenue of the physical or virtual stores without however increasing stock turnover, or a combination of these advantages, without however requiring the replacement of physical transaction systems (101, 107, 109) with new physical transaction systems, or an extensive re-engineering of the set of instructions underlying the functionality of virtual transaction checkouts, such as checkout 305 in FIG. 5.

### OBJECT OF THE INVENTION

It is an object of the present invention to provide a method of configuring a transaction checkout with additional functionality, which functionality is likely to increase the number of customers accessing a physical or virtual retail environment and the transaction conversion rate of virtual stores, and which is suitable for increasing the revenue of the physical or virtual stores without however increasing stock turnover.

It is another object of the present invention, to provide a method of configuring a transaction checkout with additional functionality, without requiring the replacement of physical transaction systems or an extensive re-engineering of the set of instructions underlying the functionality of virtual transaction checkouts.

### SUMMARY OF THE INVENTION

According to an aspect of the present invention, a method is provided for configuring a transaction checkout at a local network-connected terminal, the method comprising the operations of loading a checkout module and transaction data from a remote terminal; loading a conditional transaction module; processing transaction data with the conditional transaction module; providing a user with an input choice to either confirm the transaction data to the remote terminal or chance the transaction data; increasing the price data of the transaction data if the transaction data chancing is unsuccessful; and decreasing the price data of the transaction data if the transaction data chancing is successful.

According to another aspect of the present invention, a data processing terminal is provided, which has processing means, memory means, data input and output means and networking means, the memory means storing instructions which configure the processing means to configure a transaction checkout for performing the operations comprising loading a checkout module and transaction data from a remote terminal; loading a conditional transaction module; processing transaction data with the conditional transaction module; providing a terminal user with an input choice to either confirm the transaction data to the remote terminal or chance the transaction data; increasing the price data of the transaction data if the transaction data chancing is unsuccessful; and decreasing the price data of the transaction data if the transaction data chancing is successful.

According to yet another aspect of the present invention, a data carrying medium is provided which has a set of instructions encoded thereon which, when processed by processing means of a network-connected terminal, configure the processing means to configure a transaction checkout for performing the operations comprising loading a checkout module and transaction data from a remote terminal; loading a conditional transaction module; processing transaction data with the conditional transaction module; providing a terminal user with an input choice to either confirm the transaction data to the remote terminal or chance the transaction data; increasing the price data of the transaction data if the transaction data chancing is unsuccessful; and decreasing the price data of the transaction data if the transaction data chancing is successful.

In an alternative embodiment of any of the above aspects of the present invention, the operation of loading the transaction module further comprises obtaining the transaction module from a remote terminal.

### BRIEF DESCRIPTION OF THE DRAWINGS

FIG. 1 shows a physical retail environment, comprising a physical transaction checkout system having a data processing terminal,

FIG. 2 shows the constituent parts of the data processing terminal of FIG. 1 in further details;

FIG. 3 provides a representation of a virtual retail environment, comprising a data processing terminal having a video display unit displaying online or virtual transaction checkout;

FIG. 4 shows the constituent parts of the data processing terminal shown in FIG. 3;

FIG. 5 provides a representation of the virtual transaction checkout displayed by the VDU shown in FIG. 3;

FIG. 6 illustrates both a physical retail environment and a virtual environment as respectively shown in FIGS. 1 and 3, in which a physical transaction checkout and a virtual transaction checkout are configured according to the present invention;

FIG. 7 details the operational steps according to which either of the physical or virtual transaction checkouts of FIG. 6 process transaction data with a conditional transaction module according to the present invention;

FIG. 8 details the operational steps according to which the virtual transaction checkout of

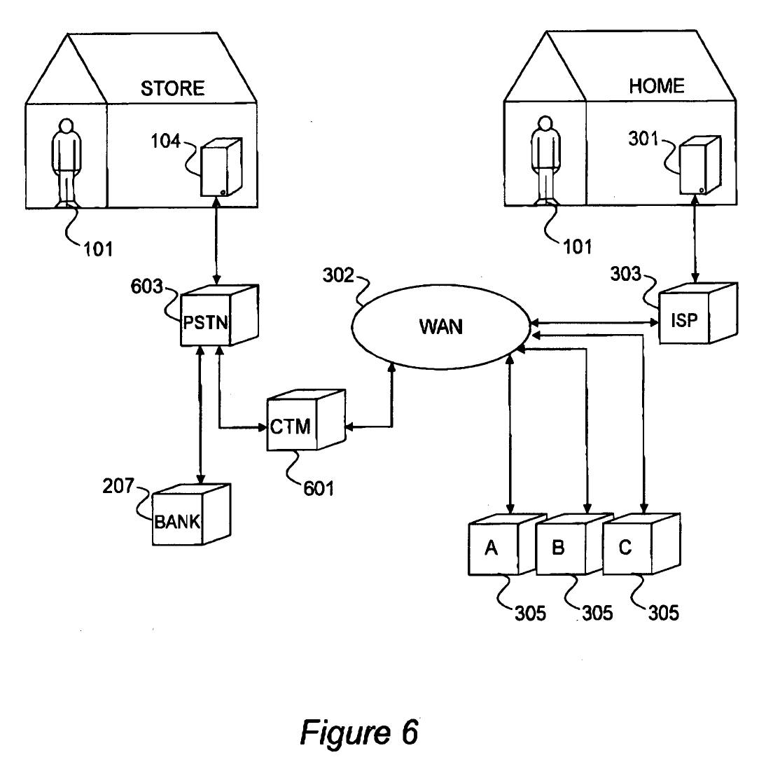

FIG. 6. processes transaction data with a conditional transaction module according to an alternative embodiment of the present invention;

FIG. 9 illustrates the contents of the respective memories of the physical and the virtual transaction checkout of FIG. 6 when processing transaction data with the conditional transaction module according to the present invention;

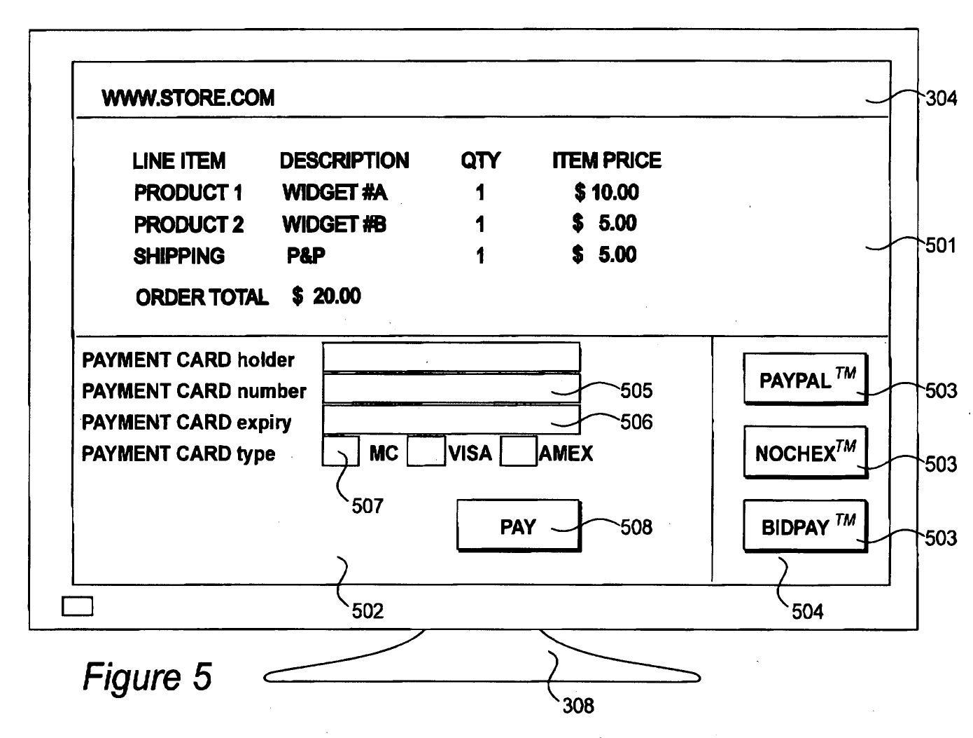

FIG. 10 illustrates the virtual transaction checkout of FIG. 5 configured by the conditional transaction module of the present invention;

FIG. 11 shows the virtual transaction checkout of FIG. 10, in which the transaction amount has been incremented by the conditional transaction module of the present invention;

FIG. 12 shows the virtual transaction checkout of FIG. 10, in which the transaction amount has been decremented by the conditional transaction module of the present invention;

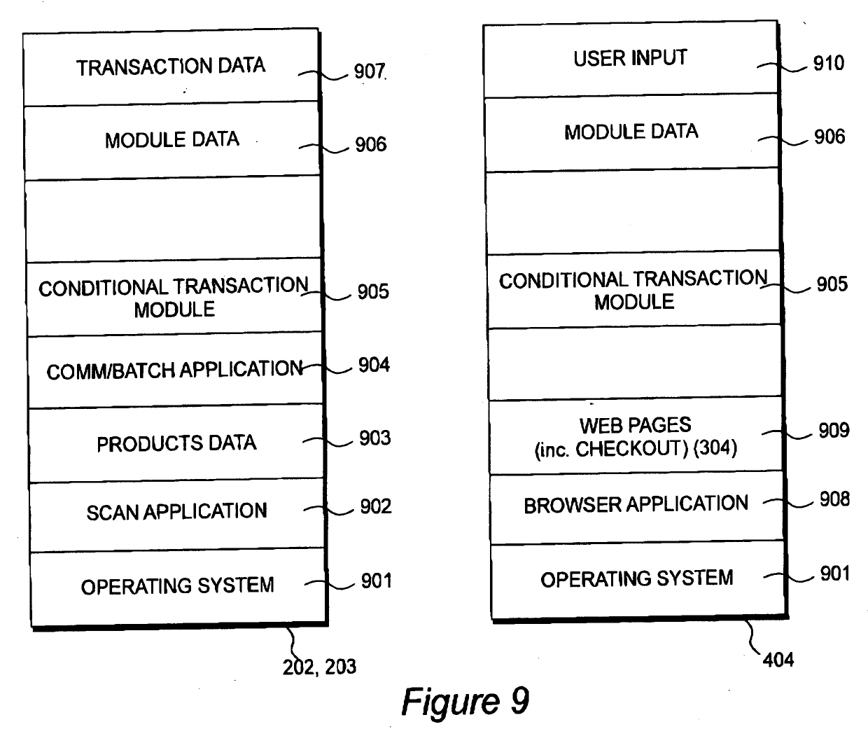

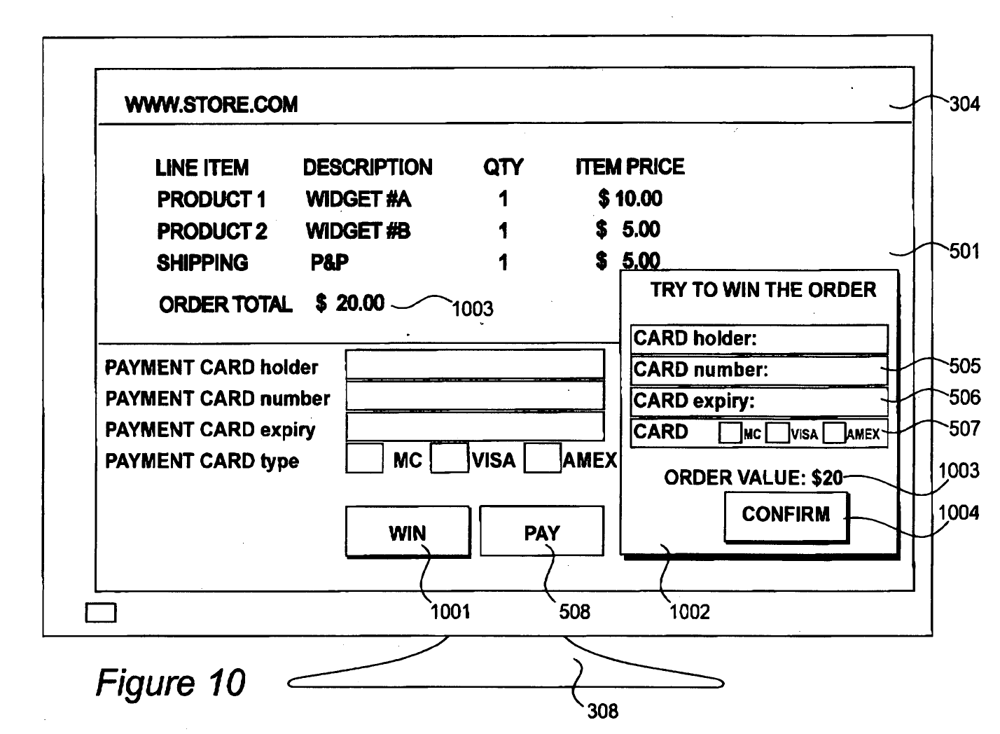

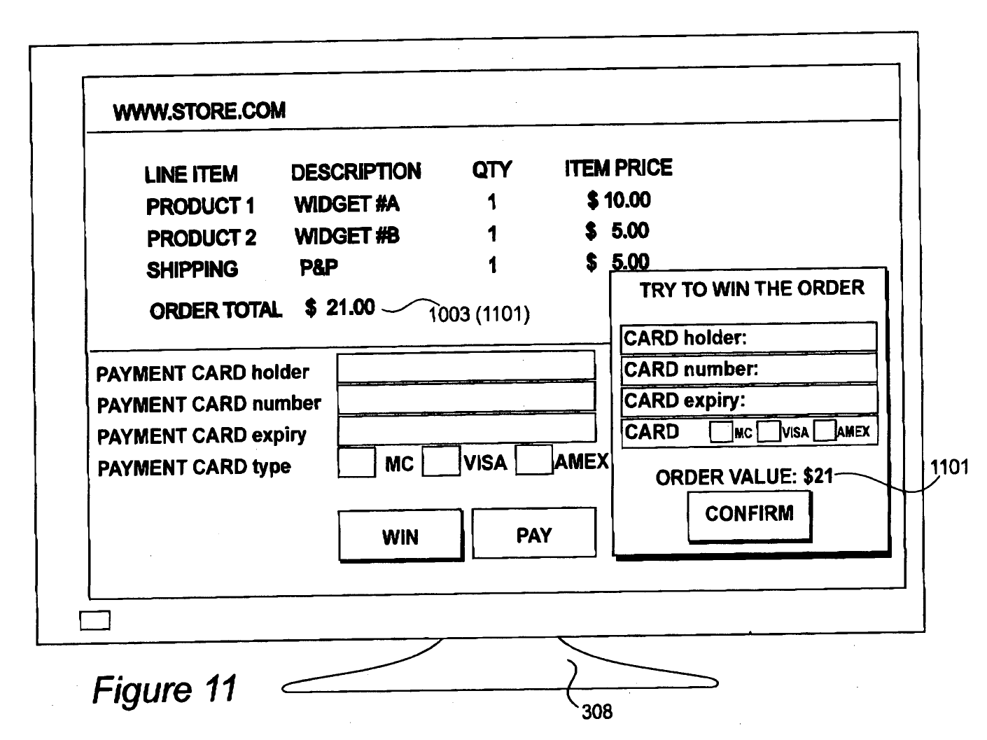

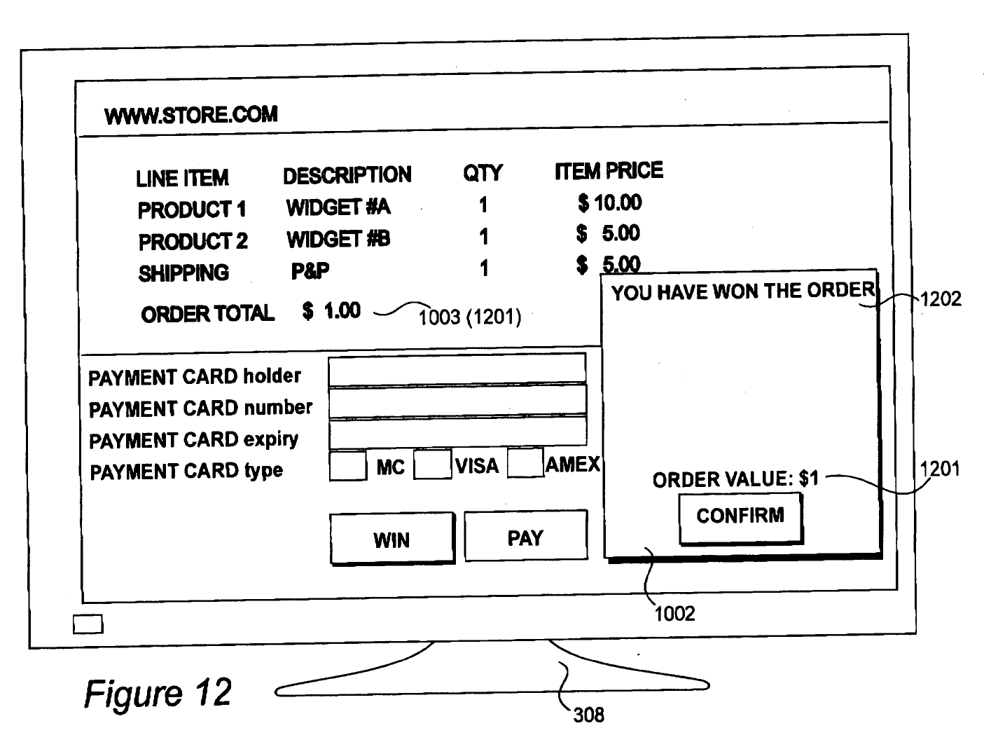

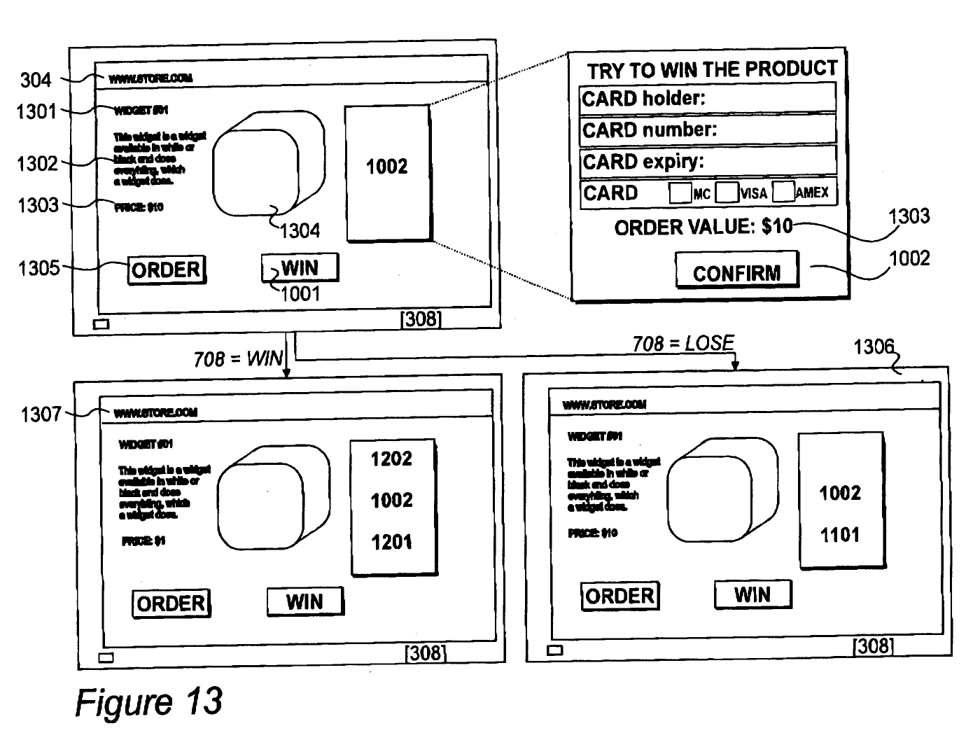

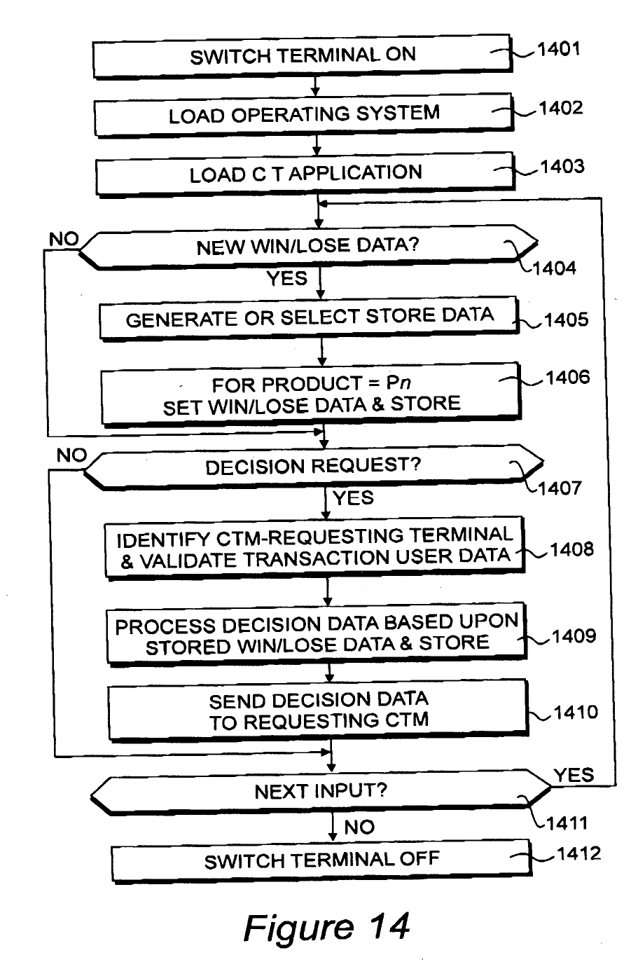

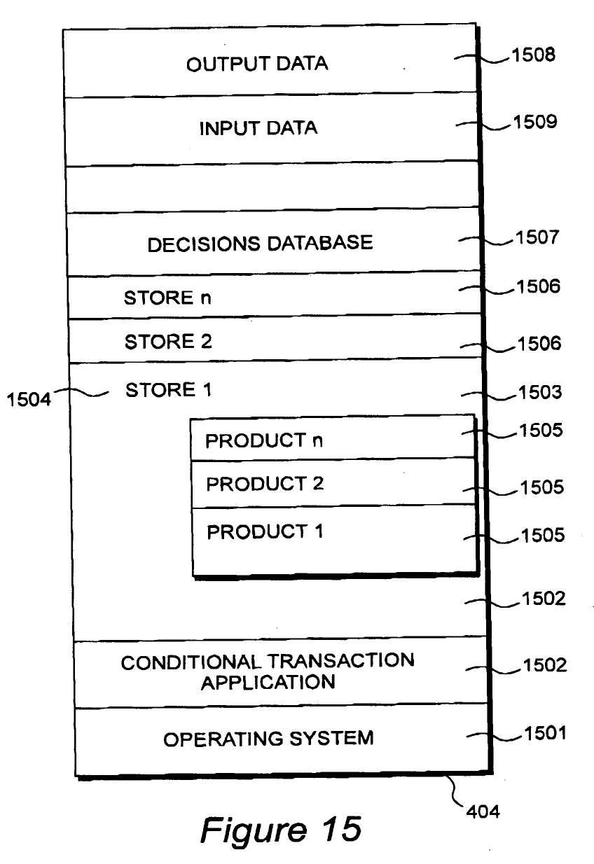

FIG. 13 provides a representation of a virtual product display configured by the conditional transaction module according to the alternative embodiment described in FIG. 8;

FIG. 14 details the operational steps according to which the conditional transaction module provider terminal shown in FIG. 6 processes data according to the present invention; and

FIG. 15 illustrates the contents of the memory of the conditional transaction module provider terminal shown in FIGS. 6 and 12.

### DETAILED DESCRIPTION OF THE DRAWINGS

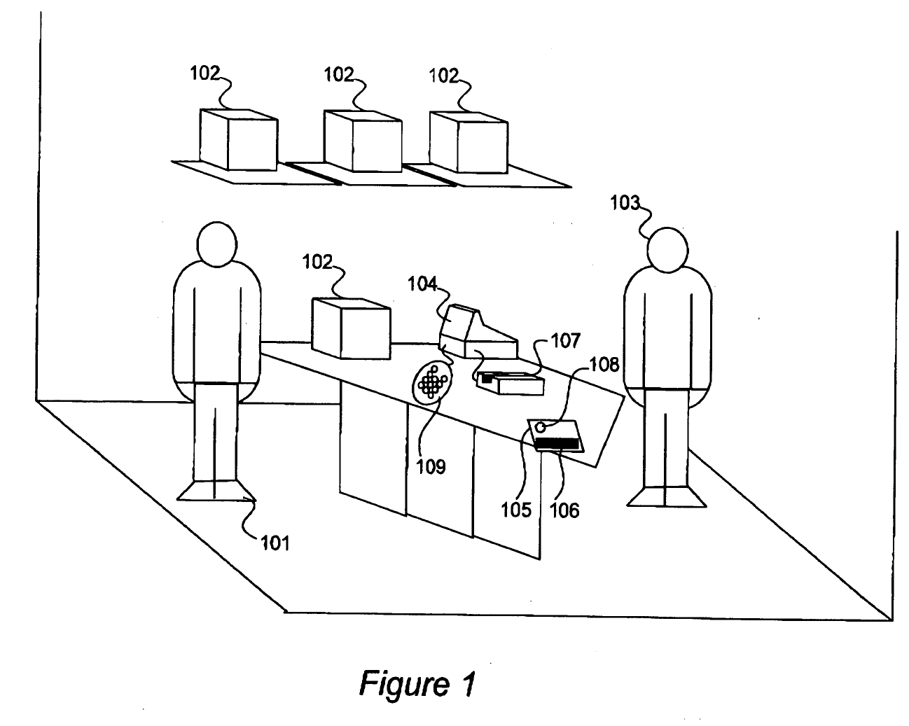

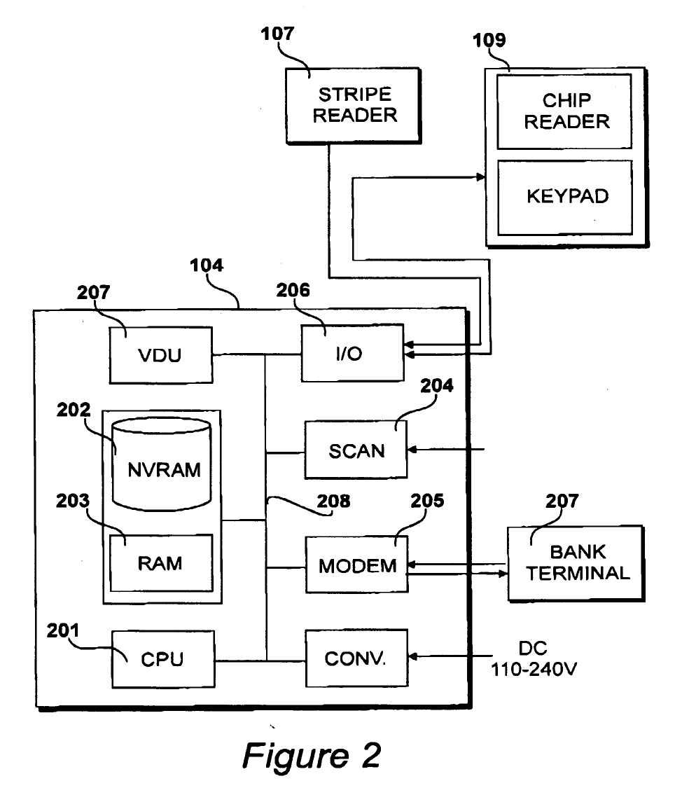

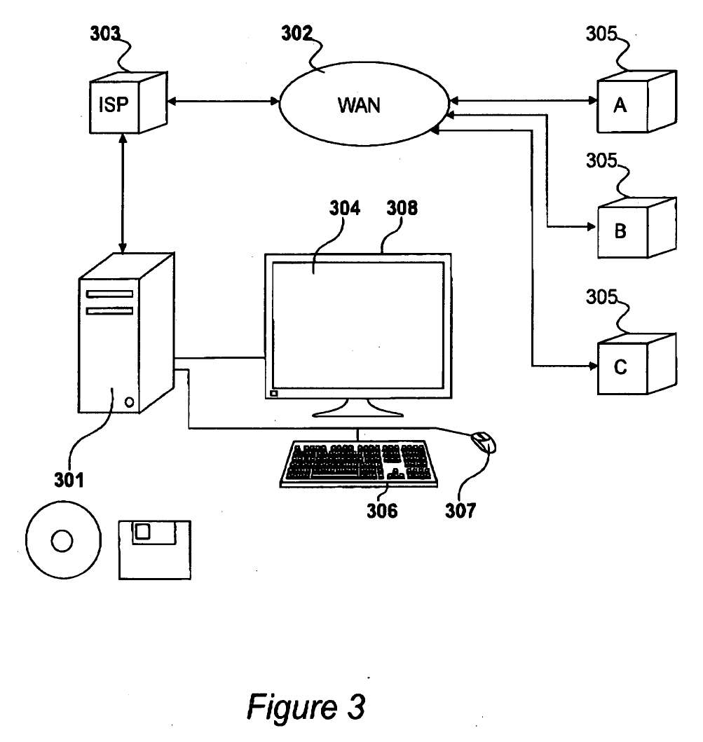

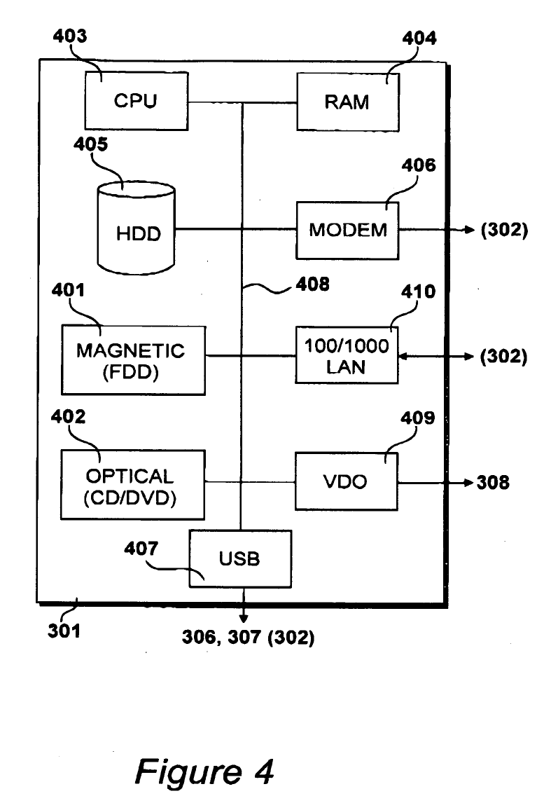

An environment is shown in FIG. 6, in which the data processing terminal 104 of the transaction checkout described in FIG. 1 is connected to both the data processing terminal 207 of a financial institution and the data processing terminal 601 of a conditional transaction module provider by means of a network connection 603 via a standard PSTN network, with which terminal 104 is interfaced with modem 205. In the same environment, the data processing terminal 301 of a customer 101 accesses any one of a plurality of virtual stores, the respective data for which is stored at a plurality of remote data processing terminals 305, via the Internet 302. Terminal 301 is also network-connected with the terminal 601 of the conditional module provider via the Internet 302.

In the environment depicted in FIG. 6, the possibility therefore exists for both terminal 104 of the physical retail environment and the terminal 301 processing and displaying virtual retail environments to send data to terminal 601 and receive data therefrom.

According to the present invention, either of the transaction checkouts are configured by a transaction module to perform the additional functionality of allowing a customer 101 to not only carry out a transaction in a physical or virtual store, but also to part take in a game of chance for decreasing the amount of the transaction in the case of a winning entry or, conversely, increasing the amount of the transaction in the case of a loosing entry.

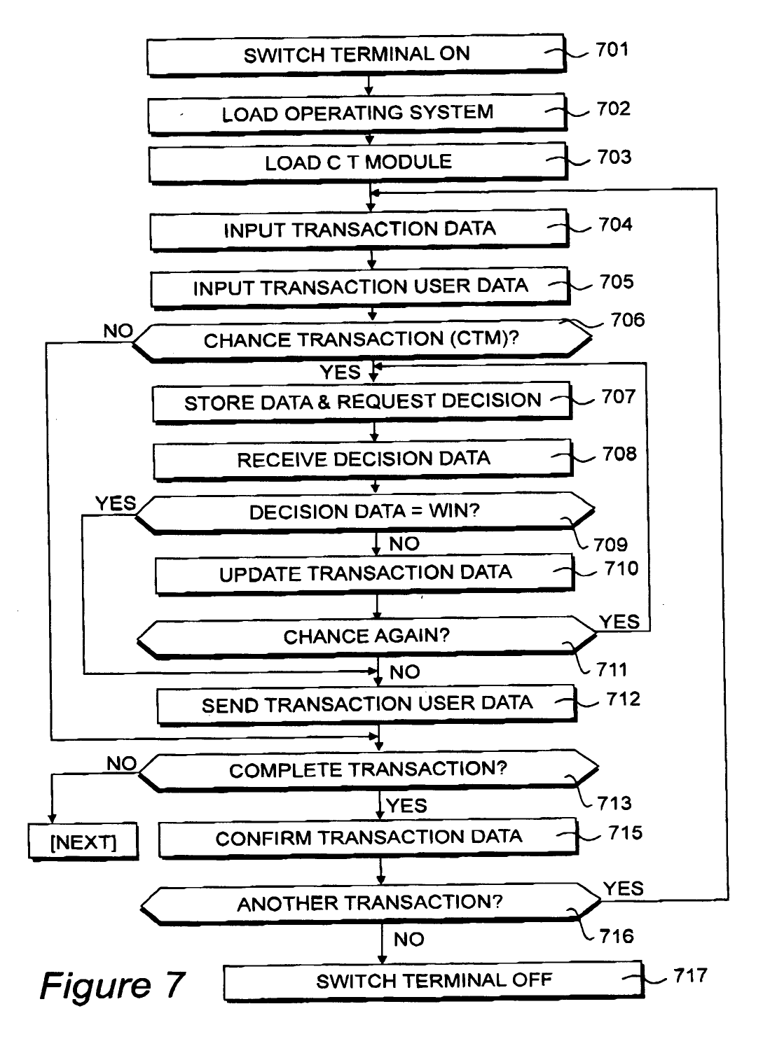

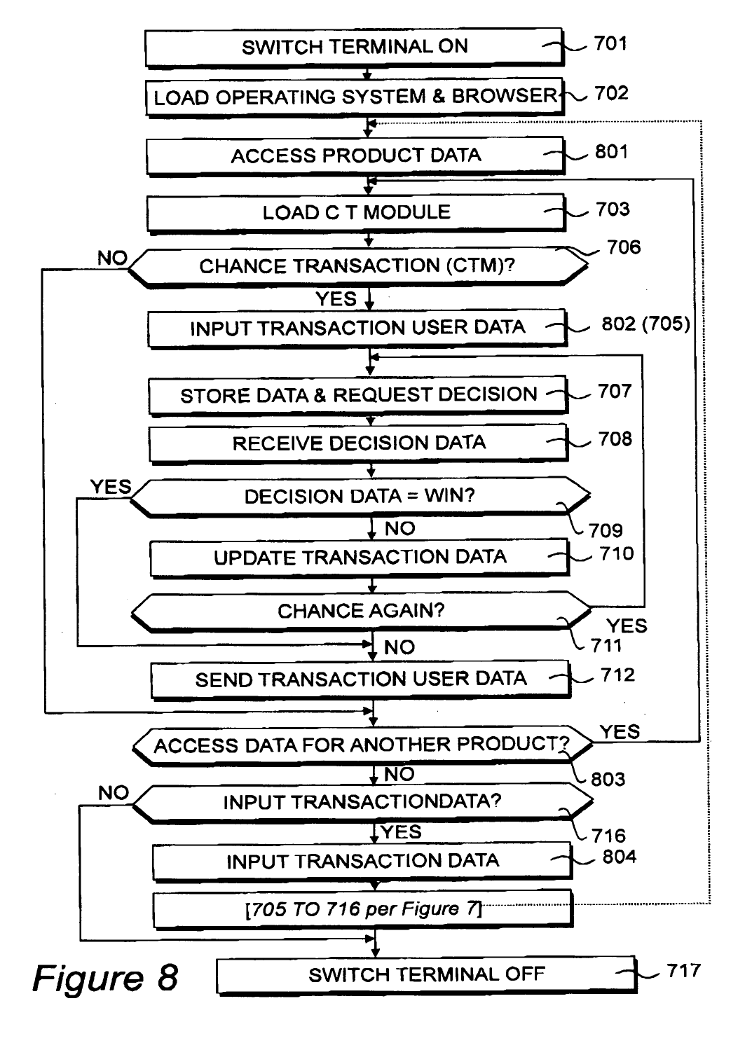

The operational steps according to which either terminal 104 or terminal 301 process data according to the present invention, are further detailed in FIG. 7. The terminal is initially started, or switched on, at the first step 701. Thereafter, an operating system is loaded into the memory of the terminal at step 702, which configures processing means within the terminal with basic data processing functionality, such as addressing data between the various constituent parts of the terminal over the bus (208, 408), reading and interpreting input data and outputting video data to a display.

A conditional transaction module according to the present invention is then loaded at step 703. In the case of a POS terminal, the CT module may be permanently stored in NVRAM 202 and is loaded substantially at the same time as the operating system of terminal 104. In the case of computer 301, the CT module may either also be loaded at start up or is downloaded from terminal 601 via the Internet 302 whenever the virtual retail environment consulted by the terminal user 101 potentially requires the functionality of the module, as will be described in further details herein below and, in the preferred embodiment, when the online or virtual transaction checkout data is requested form the virtual store terminal 305 and in alternative embodiment, when product data is instead accessed from the said terminal 305.

Transaction parameters may subsequently be entered into the terminal at step 704, which for instance comprise one or many products with respective quantities. In the case of terminal 104, step 704 will for instance involve the successive scanning of the respective bar codes of one or many products brought by customer 101 to the checkout desks depicted in FIG. 1. In the context of the virtual retail environment, step 704 will involve the iterative selection by a customer of product data accessed from a virtual store terminal 305, for instance as described in relation to FIGS. 8 and 13. Upon completing the inputting of transaction parameters, therefore the selection of products or services to purchase, a customer 101 eventually proceeds to a checkout at step 705, at which user parameters are input. Such user parameters preferably include payment details for the transaction and, in the preferred embodiment, payment card details. It will be readily understood by those skilled in the art that the present invention shall not however be limited to payment cards and particularly in the case of virtual transaction checkouts, the use of online payment accounts such as provided by Paypal™ and the like is equally contemplated herein.

A first question is asked at step 706 as to whether the customer 101 wishes to invoke the functionality of the CT module therefore whether the customer 101 wishes to partake in the game of chance to hopefully decrease or otherwise increase the amount of the transaction. If the question of step 706 is answered positively, the terminal broadcasts a request across the network to the terminal 601 of the CT module provider to obtain a decision as to whether the entry is either a winning entry or a loosing entry at step 707. The decision is preferably received in return within a very short period of time and at step 708 from terminal 601, the length of time elapsed to receive the response for instance amounting to the latency of the network 302, 603 used to broadcast the request and receive the decision in addition to the time taken to process the request and broadcast the decision at the CT provider terminal 601.

A second question is therefore asked at step 709, as to whether the decision data received from terminal 601 corresponds to a winning entry. If the question of step 709 is answered negatively, both the CT module data initialised at step 707 when first invoking the CT module and the transaction parameters are up dated at step 710, the transaction amount being incremented by the price data of the user entry and a count of winning attempts is incremented within the CT module data. A question is then asked at step 711, as to whether customer 101 wishes to partake in the game again, whereby if the question of step 711 is answered positively, control returns to step 707, so that a new decision may be requested and received and so on and so forth. Alternatively, the customer 101 does not wish to invoke the functionality of the CT module anymore and, as would be the case if the question of step 709 is answered positively and the decision data identifies a winning entry the CT module data initialised at step 707 and up dated at step 710 is sent to the CT module provider terminal 601 at step 712 for billing of the appropriate number of entries and further reconciliation of a winning entry with the respective virtual store terminal 305. A question is subsequently asked at step 701 as would be directly asked if the customer 101 chooses not to invoke the CT module a the question of step 706, as to whether the customer 101 now wishes to complete the transaction. A customer 101 may choose not to complete the transaction for any number of reasons, either in a physical retail environment (for instance refuses to sign the sales slip or is unable to remember the personal identification number for the card) or the virtual retail environment (for instance the user in the end decides not to go ahead with the order, particularly if a large number of attempts to obtain a winning decision have been undertaken and the increased transaction amount is more than the customer is willing to pay). If the question of step 713 is answered negatively, then the customer 101 may still choose to input transaction parameters in the same or in a new order, in which case control returns to step 704, or may choose to leave the physical retail environment of FIG. 1 or access product data of a different virtual store of another virtual store server 305 or any other task, whereby a further operational step shown at 714 may vary.

Alternatively, the customer 101 confirms the transaction at step 715 and a final question is asked at step 716, as to whether the customer 101 wishes to carry out a further transaction with terminal 301, or another customer 101 is queuing for a further transaction at POS terminal 104 at step 716. If the question-at step 716 is answered positively, control returns to step 714 as previously described. In the alternative, the terminal is eventually switched off at step 717.

The operational steps according to which data processing terminal 301 processes data with the CT module of the present invention according to an alternative embodiment of the present invention are further detailed in FIG. 8, in which the terminal is again started at step 701 and the operating system of the terminal is again loaded at step 702.

According to the alternative embodiment, however, customer 101 does not input transaction parameters at step 704 but instead accesses product data from any one virtual store terminal 305 at step 801.

Product data may be broadcast by the said any one of virtual store terminals 305 as a web page 304 including any textual, graphical and/or audio data and may include a user-selectable button for adding the product to a virtual shopping cart, i.e. inputting transaction parameters according to step 704. Alternatively, product data may be broadcast by a search engine such as Google™ under the form of a listing of URLs (Uniform Resource Locators) which are user-selectable representations of the respective network addresses of data stored at any one of the said virtual store serves 305 and related to a product which customer 101 is interested in locating and possibly purchasing.

According to the alternative embodiment, however, upon accessing the virtual store page 304 containing the product data accessed at step 801, or upon receiving the network address of same in a URL listing provided by a search engine as described immediately above, the CT module is loaded as per step 703 and a user-selectable representation of the module functionality is generated for output to the display 308 as part of the web page 304 also output to the display 308.

The question of step 706, as to whether potential customer 101 wishes to invoke the functionality of the CT module is next asked, whereby the potential customer 101 is offered the chance to try to win the product accessed at step 801 without however having to initiate a transaction procedure, for instance with inputting transaction parameters according to step 704 and so on and so forth. Therefore, if the question of step 706 is answered positively, the user inputs user parameters at step 802 as he would according to step 705 in the preferred embodiment, so that payment details may again be initialised as part of the CT module data at step 707, when a request for a decision is again broadcast to the terminal 601 of the CT module provider. Process steps 707-712 are thereafter performed as hereinbefore described and upon the potential customer 101 deciding not to invoke the functionality of the CT module anymore and answer the question of step 711 negatively, and the CT module data being sent back to the terminal 601 a question is asked at step 803, as to whether the potential customer 101 now wishes to access new product data, of the same virtual store for another. If the question at 803 is answered positively, control returns to step 801 and so on and so forth.

Alternatively the question of step 803 is answered negatively and the user is asked at step 804, as to whether the product data accessed at step 801 should be selected for purchase, and therefore transaction parameters input, at the nominal price at which the virtual store offers the product for sale. If the question of step 804 is answered positively, then transaction parameters are input according to step 704 and the reminder of the transaction process conforms to the previously described steps 705-716. The question of step 716 may eventually be answered positively, so that in the alternative embodiment, control returns to the question of step 804. Alternatively, the question of step 716 or the question of step 804 is answered negatively, whereby the terminal may eventually be switched off at step 717, as previously described.

The memory means 202, 203 of POS terminal 104 and the memory 404 of terminal 301 are both shown in FIG. 9 and the respective contents thereof according to the present invention are respectively illustrated. For the purpose of not unnecessarily obscuring the present is description, the memories 202 and 203 of POS terminal 104 are represented as a single memory in FIG. 9, since the respective contents thereof maybe accessed by CPU 201 at any time during run time. The memory therefore includes an operating system 901, a bar code reading/scanning application 902, product data 903 that may comprise product description and/or part number and unit price, a communication and batching application 904, used to communicate payment card transaction data to the terminal 207 of financial institutions once or many times a day for account reconciliation as described in relation to FIG. 1. The memory also includes the conditional transaction module 905 of the present invention, the respective module data for which is shown at 906, in addition to transaction data at 907.

The memory 404 of terminal 301 also includes an operating system 901 for ensuring basic data and data file processing functionality. Memory 404 includes a browser application 908, which translates alphanumerical and selection data input by the user 101 into data requests to remote terminals, and processes data broadcast from the said remote terminals in return as web pages 304, shown at 909 and which eventually comprises the virtual transaction checkout. The conditional transaction module 905 is also stored in memory 404, and those skilled in the art of programming data processing terminals will appreciate that the set of instructions embodying the functionality of CT module 905 may vary to a smaller or larger extent, depending up on the particulars of the OS 901 and the data processing capabilities of the device which the module is intended to configure. Module data 906 is therefore also represented in memory 404 and user input 901 includes the afore-mentioned alphanumerical and selection data, which comprises transaction parameters, user parameters and selections defining answers to the procedural/ operational questions described in FIGS. 7 and 8.

Module data 906 comprises locally-input user data for sending back to terminal 601 at step 712, and this user data includes at least the user parameters consisting of payment details such as payment card data or online financial account data, as well as a count of the number of decisions requested according to steps 706 to 711. Module data 906 also comprises price data, and at least the total order amount in the preferred embodiment of FIG. 7, and at least the product or service price in the alternative embodiment of FIG. 8. Module data 906 also comprises decision data, which is received from remote terminal 601 at step 708 in the preferred embodiment.

In an alternative embodiment, decision data may be locally processed and output by the CT module 905 loaded at step 703 further to accessing product data at step 801, so for instance wherein the CT module is downloaded from terminal 601 for loading into the memory 404 of terminal 301 at the said step 703 and is downloaded complete with decision rule data. In this alternative embodiment and with reference to the description of FIG. 8, the step 707 of requesting decision data does not involve broadcasting a request message to terminal 601, but instead processing the request locally with CPU 403 according to the decision rule data of CT module 905.

The virtual transaction checkout shown in FIG. 5 according to the prior art is again shown in FIG. 10 as configured by the CT module 905 according to the present invention. The transaction checkout 304 comprises substantially the same sections 501, 502 and optionally 504, as well as the same user-selectable buttons 503, 507, 508 and data entry fields 505, 506. According to the present invention, if the virtual store 305 provides the functionality of CT module 905 in conjunction with terminal 601, the transaction checkout 304 comprises a further user-selectable button 1001, the selection of which by customer 101 in effect answers the question of step 706 positively.

In the preferred embodiment, the selection by customer 101 of button 1001 initiates the processing of the set of instructions embodying the CT module 905 by CPU 403, and a graphical user interface 1002 is output to VDU 308, and which comprises data entry fields 505, 506 and 507 which, depending upon the preferred implementation, are either respectively and automatically completed with user parameter data 901 already inputted by customer 101 within transaction checkout section 502 before selecting button 101, or require the re-inputting of said user parameter data 901 therein (for instance as a security measure), or require the input of said user parameter data for the first time if the customer 101 has not yet inputted appropriate data within section 502. The total amount of the order for which a “win or loose” decision is sought, which is shown at 1003. GUI 1002 also includes a user-selectable “confirmation” button 1004, which the customer 101 selects to request and obtain the “win or loose” decision, which is only provided if the user parameters in data entry fields 505-507 of GUT 1002 have been filled with appropriate data.

In the example shown in FIG. 10, the GUI 1002 of CT module 905 is represented as a window overlaid over transaction checkout 304, which is known to those skilled in the art as a “pop up window”. It will be readily apparent to those skilled in the art, that this configuration is provided by way of example only and that alternative embodiments contemplate the reconfiguration of web page/ transaction checkout 304 instead, or any other graphical user interface representation deemed appropriate. For instance, the GUI 1002 may not be required at all if customer 101 has inputted the appropriate data in data entry fields 505-507 of section 502 and the selection by customer 101 of button 1001 performs the decision request described in relation to button 1004, itself Similarly, it will be readily understood by those skilled in the art that the representation of FIG. 10 is inappropriate in the context of a physical retail environment using a POS terminal 104, wherein processing operations 706-711 are performed with one or a plurality of binary “yes/no” data input, for instance using key pad 109.

Further to requesting a “win or loose” decision according to step 707, i.e. selecting button 1001 and/or 1004, the decision received in return either identifies a winning entry, in which case the order total 1003 is decremented, or identifies a loosing entry, in which case the order total 1003 is incremented, for instance by the unit price associated with requesting a decision, i.e. partaking in the game of chance. The virtual transaction check out 304 of FIG. 10 is again represented in FIG. 11, in which a “losing entry” decision has been received at step 708 in the example. In the example still, the unit price for each decision is $1, whereby the order total 1003 has been suitably incremented by $1. With reference to the description of FIG. 7, the customer 101 may then invoke CT module 905 again by answering the question of step 711 positively with selecting button 1001 again, and the GUI 1002 subsequently output now shows the updated order total at 1101 further to the updating of the module data 906 at step 710.

Conversely, the transaction checkout 304 of FIG. 10 is again shown in FIG. 12, further to receiving a “wing entry” decision at step 708, and therefore wherein the order total has been decremented (1201) in consequence. In the example, the amount of the decrease provided by the store 305 of the example is the total amount 1003 of the store order, but excluding the price associated with the number of decisions requested GUI 1002 is suitably updated with a notification 1202 of the “sin” decision. It will be readily apparent to those skilled in the art, that the amount by which the transaction amount may be incremented or decremented depends entirely upon the commercial parameters of the store, which are preferably communicated to the CT module provider terminal 601 before the functionality of CT module 905 is provided to visiting customers 101. Again, it will be readily understood by those skilled in the art that the functionality of CT module 905 as described in relation to a virtual transaction checkout 304 in FIGS. 10-12 may be easily implemented in a POS terminal 104, reprising an identical processing logic.

With reference to the description of the alternative embodiment provided in relation to FIG. 8, a web page 304 is represented on VDU 308 in FIG. 13. The user 101 accesses product data 909 from a remote virtual store 305 at step 801, the product data including alphanumerical data such as a product name or description 1301 a product description 1302 and a product unit price 1303, as well as image data such as a product photograph 1304. In accordance with known principals of virtual store product page configuration, the web page 304, 909 also include a user-selectable button 1305, which the user/customer 101 would select to add the particular product to a virtual shopping cart and the eventual inclusion of said data in a virtual transaction checkout 304 shown in FIGS. 10-12, within order description section 501.

According to the alternative embodiment, the product web page 304 again includes a user-selectable button 1001, substantially as described hereinbefore and the selection of which by the customer 101 again generates GUI 1002 and constituent parts 505-507 and 1004 thereof, but this time including the product prize data 1303 instead of an order total 1003. In conformance with the present description, the customer 101 may eventually button 1004, whereby a decision returned according to step 708 may identify either a winning entry or a loosing entry.

In conformance with the present description still, if the decision of step 708 identified a loosing entry, the product price data 1303 is incremented instead of an order total 1003, an this outcome is illustrated by an updated product page 1306, in which the product price 1303 has been incremented by $1, amounting to the cost associated with requesting a decision as previously described in this example. The customer 101 may request a further decision by again selecting button 1001, or alternatively still decide to purchase the product by selecting button 1305, in which latter case the price data in the eventual virtual transaction checkout 304 will correspond to that shown in product page 1306, as opposed to product price 1303.

Conversely, if the decision of step 708 defines a winning entry, then again in accordance with the present description, the product price data 1303 is decremented and this outcome is shown at 1307 in which, in accordance with the example, the price data 1303 has been reduced to only the cost associated with requesting the decision, per the description of FIG. 12. The customer may now select button 1305 for adding the product to a virtual shopping cart and the eventual online transaction checkout 304 will include the selected products at the unit price shown at 1307.

The operational steps according to which terminal 601 of the provider of CT module 905 processes data received from consumer terminals 301 or POS terminal 104 according to the present invention, are farther detailed in FIG. 14. The terminal is yet again initially started, or switched on, at the first step 1401. Thereafter, an operating system is loaded into the memory 404 of the terminal at step 1402, for instance of the same operating system as shown at 901, which configures the processing means 403 within the terminal 601 with basic data processing functionality, such as addressing data between the various constituent parts of the terminal over the bus 408, reading and interpreting input data and outputting decision data and optionally video data to a display 308.

Further to the OS-loading step 1402, a conditional transaction application is loaded at step 1403, as a set of instructions which configure the processing means of terminal 601 to process local and remote data as described in further details hereinafter. A plurality of physical or virtual stores may benefit from the present invention, whereby the decision parameters for processing and outputting a “win or loose” decision may vary to a fairly vast extent, since these are dependent upon the particular motives of each of such store and the respective costs and/or profitability of one or more products of said store or stores for which the CT module 905 may be invoked.

A fist question is asked at step 1404 as to whether new “win or loose” decision parameters should be input as part of a set of data records loaded by terminal 601 at the same application-loading step 1403. If the question of step 1404 is answered positively, then at step 1405, a data record uniquely identifying a physical or virtual store must first be generated, whenever a retail environment wishes to provide the functionality of CT module 905 to its customers 101 for the first time. Such a data record may include data uniquely identifying both the store and the terminal 104 and/or 305, to ensure that decision requests of steps 707 are routed back to the correct requesting terminal 104 or customer requesting terminal 301 via the correct store terminal 305.

It is expected that a store may want to offer the functionality of CT module 905 for a plurality of products Pₙ, each of which may have varying levels of profitability and/or inventory levels and other such parameters which influence directly or indirectly the number of “winning entry” decision to be issued. Such parameters are therefore input at step 1406 in respect of each product for which CT module 905 will be used for the respective store that a record currently selected and/or generated at the previous step 1405.

A second question is asked at step 1407, which is asked immediately after the question of step 1404 if this latter is answered negatively, as to whether a decision request has been received form a remote terminal over the network connections of terminal 601. If the question of step 1407 is answered positively, then the CT application of step 1403 extracts data uniquely identifying the requesting terminal, which has issued the request at step 1408 and, in addition to validating the authenticity of the user parameters entered in appropriate data entry fields of GUI 1002, also matches the extracted data against the set of data records loaded at step 1403 and optionally updated according to steps 1405 and 1406, in order to match the request to the appropriate store, product and “win or loose” conditional transaction parameters set according to step 1406.

At the next step 1409, the CT application processes a random decision for the combination of store and product matched at step 1408, based on the corresponding transaction parameters, and maintains a record of the request received at step 1407 and the decision reached at step 1409, before broadcasting the data output at the said step 1409 as the decision to the requesting terminal at step 1410. A question is then asked at step 1411, as to whether any further input data has been received, which is also asked if no decision request has been received at step 1407. If the question of step 1411 is answered positively, control returns to the question of step 1404 and a determination is made as to whether the next input identified in step 1411 comprises data for generating or updating transaction decision parameters or whether this next input comprises data of a decision request, aid so on and so forth. Conversely, if the question of step 1411 is answered negatively, then the terminal 601 may perform any manner of other data processing tasks, for instance involving liasing with the respective terminals 104, 305 of client stores for reconciliating data of loosing entries, winning entries, revenue and apportioning of revenue between the stores and the CT module provider. Terminal 601 may eventually be shut down at step 1412.

The memory means 404 of terminal 601 is shown in FIG. 15 and the respective contents thereof according to the present invention are respectively illustrated at run time. The memory 404 includes an operating system 1501 loaded at step 1402, the CT application 1502 loaded at step 1403 and a plurality of data records as described in relation to the description of steps 1405 and 1406 herein before.

An example of a store data record is shown at 1503 as comprising data 1504 uniquely identifying the physical or virtual store and/or its single terminal 104, 305, in addition to data 1505 defining transaction decision parameters in respect of each product for which CT module 905 may be involved. Those skilled in the art will easily understand that the transaction decision parameters may be applied to any other commercial variable and not necessarily in respect of individual products, therefore for instance transaction decision parameters may be defined in relation to ranges of order amounts, or the like. Further store data records 1506 are shown in FIG. 15 to illustrate the possibility of a plurality of respective store data sets, substantially identical to data set 1503.

A compilation of data records is shown as a database 1507, which corresponds to the unique data records maintained by the CT application at step 1409 of each unique decision provided in reply to each decision request received at step 1407.

Input data 1508 is also shown in memory 404 of terminal 601, which comprises locally-input data, for instance data input according to steps 1405 or 1406 to generate or update records 1503, 1506, in addition to remote data received from remote terminals and comprising decision requests, user parameters for validating payment data at step 1408 and store and customer terminal network identification data. Output data 1509 is shown in memory 404 and comprises at any given time decision data output at step 1409 and yet to be broadcast at step 1410, CT module 905 to be broadcast to any user terminal 301 when accessing product data and requiring its functionality.

According to the present invention therefore, transaction checkouts may be easily configured with the additional functionality provided by CT module 905, for instance in order to increase any of the number of customers 101 accessing a physical or virtual retail environment, increase the transaction conversion rate of virtual stores (understood as orders confirmed and paid for, as apposed to orders placed up to a point but never actually confirmed), increasing the revenue of the physical or virtual stores without however increasing stock turnover, or a combination of these advantages, without however requiring the replacement of physical transaction systems (101, 107, 109) or an extensive re-engineering of the set of instructions underlying the functionality of physical transaction checkouts 104 or virtual transaction checkouts 304.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of performing a transaction for a product or service at a store having a transaction checkout, comprising the steps of:
for a customer initiating a transaction at the store, configuring the transaction checkout of a store with a module for a game of chance;
for the customer using the module for a game of chance successfully, decreasing the transaction amount;
for the-customer using the module for a game of chance unsuccessfully, increasing the transaction amount;
for the customer not using the module for a game of chance, maintaining the transaction amount; and
completing the transaction.

2. A method according to claim 1, wherein the store is an online store.

3. A method according to claim 2, wherein the step of initiating a transaction comprises the selection of at least one item in the store.

4. A method according to claim 2, wherein the step of initiating a transaction comprises the selection of a result of an Internet search engine identifying at least one item in the store.

5. A method according to claim 2, wherein the step of initiating a transaction comprises the selection of the store transaction checkout.

6. A method according to claim 1, wherein the store is a physical store.

7. A method according to claim 6, wherein the transaction checkout is a point of sale terminal.

8. A method according to claim 1, comprising the further step of charging the customer an amount for each use of the module.

9. A method according to claim 8, wherein the increase in the transaction amount is an amount charged for each use of the module.

10. A method according to claim 1, wherein the decrease in the transaction amount is all or a portion of the transaction amount.

11. A method of configuring a transaction checkout at a local network-connected terminal, comprising the operations of:
loading a checkout module and transaction data from a remote terminal;
loading a conditional transaction module;
processing transaction data with the conditional transaction module;
providing a user with an input choice to either confirm the transaction data to the remote terminal or chance the transaction data;
increasing the price data of the transaction data if the transaction data chancing is unsuccessful; and
decreasing the price data of the transaction data if the transaction data chancing is successful.

12. A method according to claim 11, wherein the remote terminal is an online store.

13. A method according to claim 12, wherein the transaction data comprises the selection of at least one item in the store.

14. A method according to claim 12, comprising the further step of performing an Internet search with a search engine for the at least one item in the store before the checkout module and transaction data.

15. A method according to claim 11, wherein the network-connected terminal is located at a physical store.

16. A method according to claim 15, wherein the network-connected terminal is a point of sale terminal.

17. A method according to claim 11, comprising the further step of charging the customer an amount for each input to chance the transaction data.

18. A method according to claim 17, wherein the increase in the transaction amount is the amount charged for each use of the module.

19. A method according to claim 11, wherein the decrease in the transaction amount is the entire transaction amount.

20. A method according to claim 11, wherein the decrease in the transaction amount is a portion of the transaction amount.

21. A system for performing a transaction for a product or service at a store, the system comprising:
a transaction checkout for a customer to initiate and complete a transaction thereat;
a module for a game of chance with which to configure the transaction checkout when a customer initiates a transaction, the module for a game of chance configuring the transaction checkout to:
decrease the transaction amount if the customer uses the module for a game of chance successfully,
increase the transaction amount if the customer uses the module for a game of chance unsuccessfully,
complete the transaction for the transaction amount whether the customer uses the module for a game of chance successfully, unsuccessfully or not at all.

22. A system according to claim 21, wherein the store is an online store.

23. A system according to claim 22, further comprising selection means for a customer to select at least one item in the store therewith.

24. A system according to claim 23, wherein the selection means is a network address for the data embodying the at least one item.

25. A system according to claim 24, further comprising an online search engine application for finding the at least one item in the store by way of its network address.

26. A system according to claim 21, wherein the store is a physical store.

27. A system according to claim 25, wherein the transaction checkout is a point of sale terminal.

28. A system according to claim 21, wherein the module for a game of chance further configures the transaction checkout to charge the customer an amount for each use of the module.

29. A system according to claim 28, wherein the increase in the transaction amount is an amount charged for each use of the module.

30. A system according to claim 21, wherein the decrease in the transaction amount is all or a portion of the transaction amount.

31. A data processing terminal having processing means, memory means, data input and output means and networking means, the memory means storing instructions which configure the processing means to configure a transaction checkout for performing the operations comprising:
loading a checkout module and transaction data from a remote terminal;
loading a conditional transaction module;
processing transaction data with the conditional transaction module;
providing a terminal user with an input choice to either confirm the transaction data to the remote terminal or chance the transaction data;
increasing the price data of the transaction data if the transaction data chancing is unsuccessful; and
decreasing the price data of the transaction data if the transaction data chancing is successful.

32. A terminal according to claim 31, wherein the remote terminal is an online store.

33. A terminal according to claim 32, wherein the transaction data comprises the selection of a least one item in the store.

34. A terminal according to claim 32, wherein the memory means stores instructions which configure the processing means to perform an Internet search for the at least one item in the store before loading the checkout module and transaction data.

35. A terminal according to claim 31, wherein the network-connected terminal is located at a physical store.

36. A terminal according to claim 35, wherein the network-connected terminal is a point of sale terminal.

37. A terminal according to claim 31, wherein the memory means stores instructions which configure the processing means to configure the transaction checkout for performing the further operation of charging the customer an amount for each input choice to chance the transaction data.

38. A terminal according to claim 37, wherein the increase in the transaction amount is the amount charged for each use of the module.

39. A terminal according to claim 31, wherein the decrease in the transaction amount is the entire transaction amount.

40. A terminal according to claim 31, wherein the decrease in the transaction amount is a portion of the transaction amount.

41. A data carrying medium having a set of instructions encoded thereon which, when processed by processing means of a network-connected terminal, configure the processing means to configure a transaction checkout for performing the operations comprising:
loading a checkout module and transaction data from a remote terminal;
loading a conditional transaction module;
processing transaction data with the conditional transaction module;
providing a terminal user with an input choice to either confirm the transaction data to the remote terminal or chance the transaction data;
increasing the price data of the transaction data if the transaction data chancing is unsuccessful; and
decreasing the price data of the transaction data if the transaction data chancing is successful.

42. A method of performing a transaction for a product or service at a store having a transaction checkout, comprising the steps of:
for a customer initiating a transaction at the store, configuring the transaction checkout of a store with a module for a game of chance;
for the customer using the module for a game of chance successfully, decreasing the transaction amount;
for the customer using the module for a game of chance unsuccessfully or for the customer not using the module for a game of chance, maintaining the transaction amount; and
completing the transaction.

43. A method according to claim 42, wherein the store is an online store.

44. A method according to claim 43, wherein the step of initiating a transaction comprises the selection of at least one item in the store.

44. A method according to claim 44, wherein the step of initiating a transaction comprises the selection of a result of an Internet search engine identifying at least one item in the store.

46. A method according to claim 45, wherein the step of initiating a transaction comprises the selection of the store transaction checkout.

47. A method according to claim 42, wherein the store is a physical store.

48. A method according to claim 47, wherein the transaction checkout is a point of sale terminal.

49. A method according to claim 42, wherein the decrease in the transaction amount is all or a portion of the transaction amount.

50. A method according to claim 2, wherein the online store is accessed with a mobile communication device.

51. A system according to claim 21, further comprising a mobile communication device with which the customer accesses the online store.

52. A terminal according to claim 31, wherein the data processing terminal is a mobile communication device.
